(19) United States
(12) Patent Application Publication
(10) Pub. No.: US 2015/0260541 A1
(43) Pub. Date: Sep. 17, 2015

(54) MAP CONTENT MANAGEMENT

(71) Applicant: Christopher Lacy Smith, Wellington (NZ)

(72) Inventor: Christopher Lacy Smith, Wellington (NZ)

(21) Appl. No.: 14/209,337

(22) Filed: Mar. 13, 2014

(51) Int. Cl. G01C 21/36

(52) U.S. Cl. CPC G01C 21/3679

(57) ABSTRACT

In a method and system for managing map content, an indication of a location of a building in a venue is received, and an aerial image of the building based on the location is obtained. A floor plan image of a floor of the building is received, wherein the floor plan image comprises a plurality of walls, and a user is prompted to align the floor plan image to the aerial image via a user interface. An indication of walkable areas on the floor plan image and an indication of a location of a feature on the floor plan image are received. A distance value for the floor plan image is determined, and a visitor user interface is provided for determining a route in the building for a visitor based on the distance value and the floor plan image.

### TECHNICAL FIELD

Embodiments of the present invention relate generally to map content management and, more specifically, to a system and corresponding methods for managing venue mapping.

### BACKGROUND

Venue mapping, or interior or indoor mapping, of venues allows an organization to create maps that visitors can use to navigate within or around a venue. However, venue mapping can be expensive and require involvement of engineers to implement and calibrate the solution. These costs and requirements can increase significantly as the size of the venues increases (e.g., for venues with multiple floors and multiple buildings or campuses). Organizations could benefit from a cost-effective and efficient method of creating interior maps of their venues (e.g., interactive digital maps available via a mobile application or a website) to assist visitors to the venue in navigating the venue.

### SUMMARY

An embodiment provides a method that includes receiving an indication of a location of a building in a venue, obtaining an aerial image of the building based on the location, receiving a primary floor plan image of a floor of the building, wherein the primary floor plan image comprises a primary plurality of walls, and prompting a user to align the primary floor plan image to the aerial image via a user interface. The method also includes receiving an indication of walkable areas on the primary floor plan image, receiving an indication of a location of a feature on the primary floor plan image, and determining a distance value for the primary floor plan image. The method further includes providing a visitor user interface for determining a route in the building for a visitor based on the distance value and the primary floor plan image.

In an embodiment, the method can include receiving an indication of a start location and an end location from the visitor, determining the route further based on the start location and the end location, and causing directions for the route to be provided to the visitor. The feature can be an entrance to the building, a bathroom, a stairway, an elevator, or an escalator.

In an embodiment, the method can include receiving a second floor plan image for another floor of the building, wherein the second floor plan image includes a second plurality of walls, prompting the user to align the second floor plan image to the primary floor plan image or the aerial image, receiving an indication of walkable areas of the second floor plan image, receiving a location of a conduit between the floor and the other floor, and determining a second distance value for the second floor plan image, wherein the route is determined further based on the second distance value and the second floor plan image.

In an embodiment, determining the distance value can include receiving an indication of a distance between two walls of the plurality of walls from the user, determining a scale of the floor plan based on the distance, and determining the distance value based on the scale. In an embodiment, determining the distance value can include determining a scale of the floor plan based on a dimension of the building determined from the aerial image, and determining the distance value based on the scale.

In an embodiment, the method can include receiving an update of the location of the feature on the floor plan image from the user.

In additional implementations, computing devices for performing the operations of the above described implementations are also disclosed. Additionally, in implementations of the disclosure, a computer readable storage media stores methods for performing the operations of the above described implementations.

### BRIEF DESCRIPTION OF THE DRAWINGS

The present disclosure will be understood more fully from the detailed description given below and from the accompanying drawings of various embodiments of the disclosure.

FIG. 1 illustrates exemplary system architecture, in accordance with an embodiment of the present disclosure.

FIG. 2 illustrates a map content management system, in accordance with an embodiment of the present disclosure.

FIG. 3A is a flow diagram illustrating an embodiment for a method of managing map content.

FIG. 3B is a flow diagram illustrating an embodiment for a method of generating a route for a visitor.

FIG. 4 is an illustration of a floor plan image, in accordance with an embodiment of the disclosure.

FIG. 5 is a block diagram of an exemplary computer system that may perform one or more of the operations described herein.

### DESCRIPTION

Embodiments of the present invention provide a method and system for managing map content. According to embodiments, an online authoring tool allows organizations (e.g., universities, colleges, malls, museums, businesses, governments, zoos, retail locations and stores, etc.) to define floor plans, rooms, walkways, and specific features of a venue or building, such that a route (e.g., audio or visual turn-by-turn directions or other visual indicators) between two points in the building can be calculated when requested by a visitor via a mobile application or other device. For example, an interactive interior map of a venue can be created by defining one or more buildings, defining one or more floors of the buildings by aligning floor plan images to corresponding aerial photos of the one or more buildings, determining distance values for the floors, defining walkable areas for the floors, and defining features on the floors. Upon receiving a request from a visitor to the venue for a route based on a starting point (e.g., manually entered by the visitor, such as on a mobile device, or determined via GPS, Bluetooth Low Energy Beacons, WiFi-based positioning, trilateration via cell phone towers, mobile device hardware (such as an accelerometer, a gyroscope, etc.), combinations of these, etc.) and an end point within the venue, a route including accurate directions for moving from the starting point to the end point can be provided to the visitor.

According to embodiments, navigable interior maps can be easily, remotely, and cost-effectively created from floor plan images without the assistance of engineers. In embodiments where the interior maps are stored remotely (e.g., in “cloud” storage), updates of the interior maps can be easily and rapidly made available for visitors. Further, according to embodiments where specific features (e.g., points of interest) can be defined on the map, visitors can request routes to these features. For example, a museum could define a specific location of a particular painting such that a visitor could request a route from the visitor's current location to the particular painting, and not just to the room in which the painting is located. The ability to provide such granular level navigation can be particularly helpful in large and/or crowded locations where a visitor might find locating a particular feature challenging.

In embodiments, distances between the walls, doorways, passageways, walkways, stairs, escalators, elevators, bathrooms, entrances/exits, accessibility assistance, ticket booths, emergency assistance, window, etc. on a floor plan image (i.e., dimensions of the floor plan) can be determined such that visitors can be accurately informed of how far to travel. In an embodiment, the visitor can choose to receive the shortest and/or the most optimal route, where the visitor can receive turn-by-turn textual instructions, such as “walk 10 meters and then turn left” or other directional indicators. Also, because walkable spaces (e.g., all walkable spaces) can be defined, the routes that a visitor can travel need not be specifically defined such that there are only a few restricted paths between rooms that are possible. For example, if a route is drawn down the middle of a 30 meter wide walkway and the visitor is walking along the walkway's outer limit, the directions for visitor's actual position may be inaccurate, and thus less helpful. However, because walkable spaces can be defined on the floor plan image, a route can be dynamically calculated for the visitor's actual position. Further to the example above, the route for the visitor located along the walkway's outer limit can be determined based on the walkway's outer limit.

With a system according to embodiments, the organization can provide an indication of building, e.g., by entering an address for the building or with GPS coordinates, which can be a basis for the venue's online map. In an embodiment, for multi-building venues, the organization can create an indication of each building of interest. In an example, each building can have a name or other type indicator.

The organization can then provide an indication for one or more floors for each building. A scale (e.g., to scale) floor plan image can be provided (e.g., uploaded) for each floor. For example, the floor plan image can be an architectural drawing or rendering of the floor plan of the floor. The floor plan image can be uploaded as any suitable file type (e.g., PDF, JPEG, TIF, etc.). The floor plan image can indicate walls, doors, passageways, walkways, stairs, windows, elevators, escalators, etc.

According to embodiments, the organization can designate a floor (e.g., the ground floor) to align with an aerial image (e.g., a satellite image) of the premises of the building. The floor plan image can then be aligned with the aerial image, e.g., by scaling, rotating, and/or shifting the floor plan image. As a result, the system can correlate the latitude and longitude coordinates (or other location indicators) of the building (e.g., known from the aerial image) with the internal spaces of the building shown on the floor plan image.

The organization may then align floor plan images from other or additional floors to the floor plan image that is aligned with the aerial image, e.g., by scaling, rotating, and/or shifting these additional floor plan images. This alignment may be accomplished by aligning architectural features such as exterior walls, stairwells, elevator shafts, etc. In another embodiment, each additional floor plan image is aligned with the aerial image, rather than the initial floor plan image.

Distances between elements of the floor plan image (e.g., walls and other features) can then be determined. In other words, the dimensions of the floor plan can be calculated. In an embodiment, the organization can measure a real distance (e.g., in meters or feet) between any two walls depicted on the floor plan, and then indicate this distance on the floor plan. Based on this distance and the relative distances between walls and other features shown on the floor plan, the actual distances between the walls and other features can be calculated, such that the dimensions of the floor plan are available for determining routes for visitors.

In an implementation, a corresponding actual dimension for a pixel of the floor plan image can be determined by dividing the number of pixels between the two walls related to the measurement in the image of the floor plan image by the actual measurement. Using the actual dimension that a pixel corresponds to, the distances between other walls and features can be determined based on how many pixels are between them. For example, an actual measurement is made between two walls, where the two walls are determined to be 10 meters apart. In the image of the floor plan, there are 1000 pixels between the corresponding two walls. Therefore, a pixel corresponds to an actual distance of 0.01 meters. By knowing that a pixel corresponds to an actual distance of 0.01 meters, other distances can be determined. For example, if there are 500 pixels between a wall and another feature, e.g., a statue, the actual distance between the wall and the statue can be calculated to be 5 meters.

In an implementation, if the floor plan images of different floors are scaled differently, then the operation of measuring between two walls and entering this distance may need to be repeated for each of the floors.

In another embodiment, a correlation between one or more of the floor plan images can be determined based on the alignment of the floor plan image with the aerial image. Distances in the aerial image may be known (e.g., based on GPS coordinates and/or latitude and longitude information which can be commonly associated with satellite images). For example, coordinates of the footprint of the building in the aerial image can be translated to distances, such as feet or meters. Once the floor plan image is aligned with the aerial image, these distances can be related to the floor plan image to determine distances shown in the floor plan image. For example, a distance corresponding to a pixel can be determined based on the number of pixels in a known distance, such that other distances can be determined based on the number of pixels corresponding to that other distance. In an example, a length of a building can be known to be 100 meters based on information associated with an aerial photo. Once a floor plan image is aligned with the building in the aerial photo, a number of pixels along the length of the building can be determined to be 2000 pixels. A distance corresponding to a pixel can be determined to be 0.05 meters by dividing the length of the building by the number of pixels along the length of the building, such that other distances can be calculated. For example, if there are 200 pixels between a wall and a stairwell, then an actual distance between the wall and the stairwell can be calculated to be 10 meters by multiply the number of pixels by the distance corresponding to one pixel.

In an embodiment, both the measurement between two walls submitted by the organization to determine distances and the distance determination using distances known from the aerial image being applied to the aligned floor plan image can be utilized together to determine distances with greater accuracy.

The organization can define rooms and walkable areas of the rooms shown on each floor plan image, including assigning descriptive or useful labels to these areas. In an implementation, the rooms and walkable areas can be defined via a selection tool. The selection tool may enable a user to use standard shapes (e.g., rectangles, circles, squares, triangles, etc.) and/or line tools (e.g., free-hand drawing) for non-standard shapes to designate the rooms and walkable areas.

In an implementation, each room's walkable area could be displayed in a different color or pattern, e.g., to help visually distinguish between rooms during the editing process. Further, the rooms may not be overlapping, and blank spaces may be present between the rooms and the walkable areas, e.g., where the walls are located. In an embodiment, the selection tool could prevent overlaps from occurring. In an embodiment, the selection tool could also aid in aligning the selected walkable area to the floor plan image by “snapping” or auto-positioning a selection to features of the floor plan image.

In an embodiment, each room may optionally be assigned one or more “types”, such as “bathroom” (e.g., with sub-classifications such as gender), “cafeteria”, etc., and these types may be used to provide easy navigation to visitors for these common features.

In an embodiment, walkable areas in walkways between rooms can be selected. For example, a walkway is likely to meet with or connect two or more rooms. In an implementation, walkways overlap with rooms at intersection points. For example, the intersecting points of walkways and rooms could be the locations for a visitor to enter or exit the rooms. Walkways could be defined in a similar manner as the rooms and walkable areas of the rooms using the selection tool.

In an embodiment, exit/entry points (e.g., doorways) from each room and/or the building can also be defined, along with points to access other floors (e.g., stairwells, elevators, escalators, etc.). The exit/entry points can be identified with a location on each floor and include all directions of movement (e.g., a point may be an exit point, but not an entry point). For larger exit/entry points, such as a large spiral staircase, the particular point where the visitor would access the exit/entry point, such as top and bottom access points to the spiral staircase, can be identified. In the spiral staircase example, the visitor can then be directed to the proper location for accessing the spiral staircase, rather than a railing portion of the staircase. Further, which floors are accessible via each exit/entry point can also be defined. Entry/exit points can further be classified as public or private. For example, an elevator may be able to access all floors of a building, but the top floor may be private for staff only.

According to embodiments, the exit/entry points can have a type defined, such as elevator, stair, external door, emergency exit, etc. Further, priorities can be defined for each exit type. For example, escalators maybe a “priority 1”, while stairs may be a “priority 2”, since escalators could be considered a preferred method of moving between floors. Another type may be “special accessibility”, such as an elevator to accommodate visitors that require wheelchairs or walking aids. In another example, a distance variable could be defined for priority variances, e.g., to determine when a “priority 2” type entrance/exit would be selected before a “priority 1” type entrance/exit if there is a large distance variable. For an example where the distance variable is 20 meters, if an escalator is 40 meters away and a staircase is only 10 meters away, the hierarchy of priorities could be reversed because the escalator is more than 20 meters further away than the staircase.

In an embodiment, preferred routes for visitors can be defined. For example, the organization could desire that visitors travel past a certain location, such a particular booth in a mall or a section of a store selling goods with a high popularity or profit margin. A distance variable could be defined for route variances for this certain location. For an example with a distance variable of 5 meters, if a route that would take a visitor past this certain location would not be more than 5 meters longer than a shortest route, then the visitor will be provided with a route that includes passing by this certain location.

In an embodiment, an organization could block routes through certain locations or walkable spaces, such as rooms, so that visitors would be given routes through other locations or walkable spaces, such as walkways, even if these routes were longer. For example, the organization may desire that there is less traffic through rooms, such as in rooms of a library so that traffic noise is reduced.

In an embodiment, additional features can be defined on the floor plan image, such as an exhibition, a specific artwork, a particular item in a store, emergency services, etc. In an embodiment, a user can update floor plan images to indicate that features have been relocated, portions have been closed for repairs, etc.

According to embodiments, a path-finding algorithm can determine a shortest route or an optimal route between two or more locations on one or more floors based on the defined positions on the floor plan image. Further, if a visitor has specified special accessibility requirement, the path-finding algorithm can consider these requirements when determining the optimal route. For example, a mobility-impaired visitor may require elevators and/or ramps, rather than stairs. In another example, large groups of people may prefer wide walkways rather than maneuvering through a small room. In an embodiment, the path-finding algorithm could avoid sending visitors through areas which are densely populated with other visitors by detecting (e.g., in real-time) positions of visitors from data provided by the visitors (e.g., manually or automatically via a mobile device).

In an example, a visitor can select a destination, e.g., on a mobile device or website by entering the destination via typing the destination into a text field or speaking the destination to be entered via voice-recognition software. The visitor can also select any special accessibility requirements (e.g., wheelchair access, a large group, etc.). The visitor may also enter multiple destinations or locations of interest. Quick links may be provided for entry of commonly requested destinations, such as restrooms or exits. The visitor may enter a starting point or the current location of the visitor can be detected (e.g., via a mobile device of the visitor).

Further to the example, a route (or path) can then be determined. The determination of the route can take into consideration the visitor's preferences, such as special accessibility and multiple locations as well as congested areas of the building. The route can be communicated to the visitor, e.g., via the visitor's mobile device, in any suitable manner, such as via a series of text-based directions along with distances (e.g., “walk 10 meters down the corridor towards the obelisk and turn left into the Dinosaur room), via a series of audible directions, and/or via an illustration on the floor plan image. The visitor could also be provided with information about the destination or points of interest along the route. In an example, directions for the route could recite “walk 10 meters down the corridor towards the obelisk, which is from Egypt and dates from 200 B.C., and turn left into the Dinosaur room, where a Tyrannosaurus Rex discovered near Helena, Montana, dominates the center of the room”. Further information regarding points of interest on the map could be launched from the map, according to embodiments.

In an embodiment, a compass-style arrow can also be displayed on the floor plan image to point the visitor in the proper direction. For example, the arrow could swivel as the visitor rotates the visitor's mobile device. This feature could rely on the mobile device having a hardware compass from which to gauge the direction that the user is pointing the mobile device.

In an embodiment, if the visitor requires directions between locations in separate buildings, the visitor could first be directed to an appropriate exit of the current building. Directions from the current building to the desired building (e.g., to an entrance of the desired building) could be provided via a system according to an embodiment or via a third party route-finding service. Directions from the third party route-finding service could be obtained by a system according to embodiments and provided to the visitor without additional action by the visitor. Once the visitor has entered the desired building, the system can provide the route to take within the desired building to travel to the desired location.

In an embodiment, emergency exit directions (including a shortest route to the outside of the venue) or shelter directions could be automatically be determined when triggered by the organization or by an alarm. These directions could be automatically delivered to the visitor device. For example, if a fire alarm is triggered, an alert could be automatically delivered to the user device with directions for the shortest route to exit a building of the venue.

In an embodiment, the visitor can download data (e.g., one or more routes and/or relevant data for determining a route, such as maps, features, indicators, etc.) to a device, such as a mobile device, so that the visitor does not necessarily need connectivity to a network or the Internet when the visitor desires to use or determine a route. For example, the visitor's mobile device may be enabled to connect to a network via WiFi, but may not be enabled to receive data via a cellular network. If the venue does not have WiFi connectivity available, the visitor could download the data before arriving at the venue at a location where WiFi connectivity is available. In another example, the venue could provide a visitor device to a visitor that contains or is preloaded with the data required to determine routes at the venue (e.g., maps, features, distance values, etc.) such that the visitor could use the visitor device while at the venue to determine routes of interest.

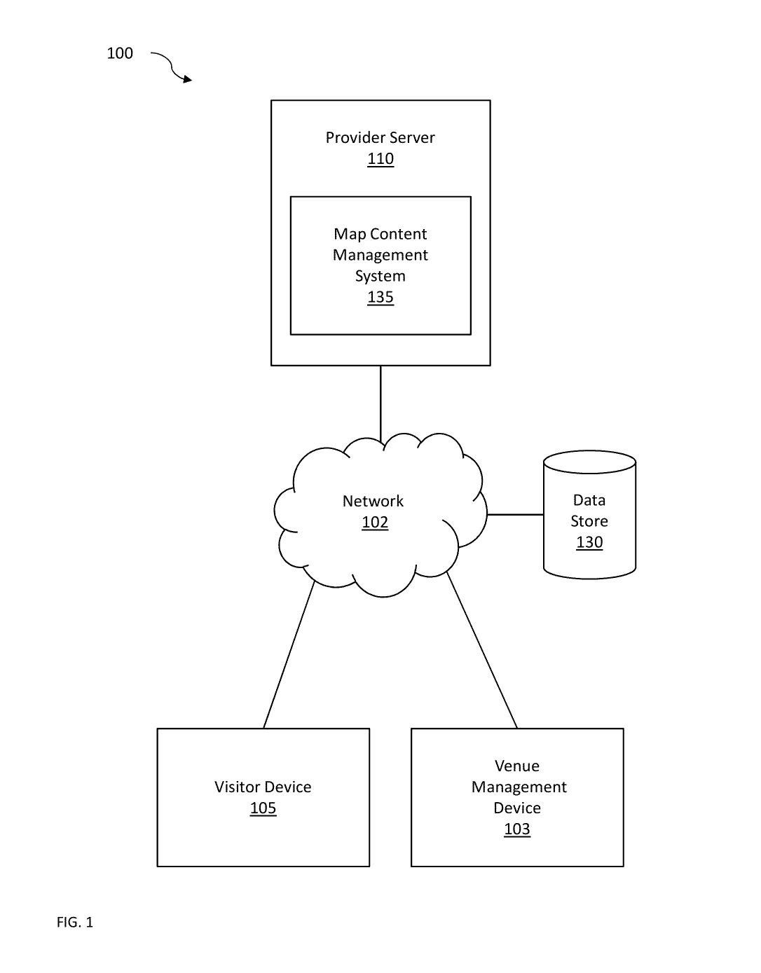

FIG. 1 illustrates exemplary system architecture 100, in accordance with an embodiment of the present disclosure. System 100 includes a visitor device 105 and an venue management device 103 in communication with (e.g., coupled to) a provider server 110 over a network 102, and a data store 130. The network 102 may be a private network (e.g., a local area network (LAN), a wide area network (WAN), intranet, etc.), a corporate network (e.g., a private network for an organization such as a corporation), a broadcast network, a public network (e.g., the Internet), a wired network (e.g., Ethernet network), a wireless network (e.g., an 802.11 network) and/or a cellular network (e.g., a Long Term Evolution (LTE) network).

The visitor device 105 and the venue management device 103 may be any type of computing device, for example, a device including a processor, a computer-readable medium, and a memory. In some embodiments, the visitor device 105 and venue management device 103 may be executing a browser application or other application adapted to communicate over Internet related protocols (e.g., TCP/IP and HTTP) and/or display a user interface. While only a single visitor device 105 and a single venue management device 103 are shown in FIG. 1, system 100 may support a large number of concurrent sessions with many visitor devices 105 and venue management devices 103.

The provider server 110 may include computing devices that have a wide range of processing capabilities such a personal computer (PC), a server computer, a personal digital assistant (PDA), a smart phone, a laptop computer, a netbook computer, a tablet device, and/or any machine capable of executing a set of instructions (sequential or otherwise) that specify actions to be taken by that machine. Embodiments of the disclosure may operate within a single server device or on multiple server devices.

Data store 130 can include one or more writable persistent storage devices, such as memories, tapes or disks. Although each of provider server 110 and data store 130 are depicted in FIG. 1 as single, disparate components, these components may be implemented together in a single device or networked in various combinations of multiple different devices that operate together. Examples of devices may include, but are not limited to, servers, mainframe computers, networked computers, process-based devices, and similar type of systems and devices.

In an embodiment, the provider server 110 includes a map content management system 135. During operation of system 100, the venue management device 103 and visitor device 105 access the map content management system 135 over network 102, where the provider server 110 receives communications from the user device 105 and the venue management device 103, and processes and/or directs these communications accordingly.

In an embodiment, management for a venue (e.g., a museum, school, business, government agency, etc.) desires to create an online interactive interior map for the venue. A user (e.g., a person employed by the venue) accesses the map content management system 135 via the venue management device 103.

The map content management system 135 can prompt the user to enter details about the venue, e.g., via a user interface such as a venue user interface. For example, the map content management system 135 can prompt the user to provide information about one or more buildings located at the venue, such as physical addresses for the buildings and/or GPS coordinates for the buildings. The map content management system 135 can then retrieve an aerial image, such as a satellite image for each of the buildings.

The map content management system 135 can also prompt the user to submit (e.g., upload) one or more floor plan images for each of the buildings. For example, the floor plan images can be any suitable type of image file, such as PDF, JPEG, TIF, etc. The floor plan image can indicate walls on the corresponding floor of the building, along with other architectural features, such as rooms, stairwells, escalators, elevators, restrooms, hallways, walkways, passageways, windows, features of interest (e.g., works of art, exhibits, information stations, etc.), emergency services, entrances, exits, doorways, etc.

Once the aerial image has been retrieved for each of the buildings and the floor plan images have been received, the user can be prompted to align the floor plan images to the aerial image of the building. For example, the user can rotate, crop, scale, and/or shift the floor plan image such that features of the floor plan image (e.g., exterior walls) are aligned with corresponding features shown in the aerial image. Other floor plan images can then be align with the previously aligned floor plan image and/or the aerial image. This process can be repeated until all of the floor plan images are aligned with each other and the aerial image of the building.

In an embodiment the map content management system 135 can automatically detect the walls in the floor plan image. In another embodiment, the user must indicate the walls in the floor plan image.

The map content management system 135 can further determine a distance value for each floor plan image. The distance value can be determined by any suitable method. For example, the distance value can be based on a scale determined by receiving an indication of a distance measurement between two particular walls of the floor plan such that the scale can be used to determine to other distances on the floor plan image. In another example, the distance value can be determined based on a scale determined by comparing a distance of the floor plan image to the a known distance of the building in the aerial image.

The map content management system 135 can further prompt the user to indicate walkable areas on the floor plan images, e.g., via a selection tool, and features such as entrances, exits, points of interest, conduits between floors, restrooms, etc.

Once the walkable areas and features have been indicated on the floor plan images and the distance value has been determined for each floor plan image, a visitor user interface can be provided for potential visitors to the venue to use to determine routes, e.g., walking routes or traveling routes, within the venue. The routes can be based on the distance value and the floor plan images.

For example, a visitor can enter a start location and an end location for the route, e.g., via the visitor device 105. The visitor can also include features that should be included on the route (e.g., passing by the restroom or a work of art that the visitor wants to view) and any special access consideration that should be taken into consideration (e.g., no stairs or avoid crowds). The map content management system 135 can then determine a route for the user based on the requirements submitted by the visitor.

The map content management system 135 can then cause directions for the route (e.g., turn-by-turn directions or other direction indicators) to be provided to the visitor, e.g., via the visitor device 105. The directions can include distances to travel, turns, conduits between floors to take, etc. If the route requires the visitor to travel between buildings at the venue, directions for traveling between buildings can also be provided. In an embodiment, the directions can be received from a third party vendor, but may be seamlessly integrated into the other directions for the route that are provided to the visitor.

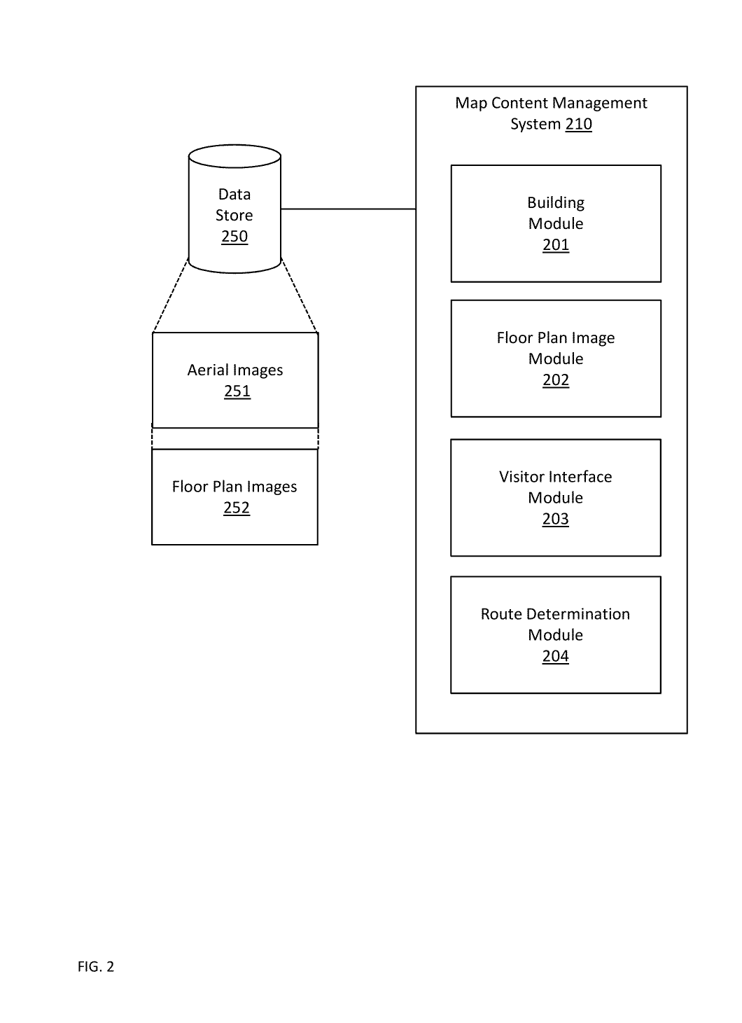

FIG. 2 illustrates a map content management system 210, in accordance with an embodiment of the present disclosure. The map content management system 210 may include a building module 201, a floor plan image module 202, a visitor interface module 203, and a route determination module 204. More or less components may be included in the map content management system 210 without loss of generality. In an embodiment, map content management system 210 is map content management system 135 and data store 250 is data store 130, shown in FIG. 1.

In an embodiment, to create an interactive interior map of a venue, the building module 201 prompts a user to indicate one or more buildings at the venue and enter information about the one or more buildings, including, e.g., addresses of each of the buildings. Based on the addresses, the building module 201 can retrieve aerial images 251 (e.g., satellite images) of the buildings, which can then be stored in the data store 250.

In an embodiment, the floor plan image module 202 can prompt the user to indicate one or more floors for each building and to enter (e.g., upload) floor plan images 252 for each floor, which can then be store in the data store 250. The floor plan image module 202 can prompt the user to align the floor plan images 252 with each other and/or with a corresponding aerial image 251 (e.g., by rotating, scaling, cropping, and/or shifting). The floor plan image module 202 can also prompt the user to indicate a location of walkable areas, walkways, passages ways, doorways, conduits between floors, restrooms, entrances, exits, points of interest, and/or any other suitable features on each of the floor plan images 252.

The floor plan image module 202 can also calculate a distance value for each floor plan image. A distance value may be different for each floor plan image or may be the same for more than one floor plan image. For example, the distance value can be calculated from a scale determined based on an actual distance between two walls on the floor plan image that is indicated by the user. The scale can be an actual distance corresponding to a pixel of the floor plan image. In another example, the distance value can be calculated from a scale determined based on a known distance in the aerial image of the building that is compared to a corresponding distance in a corresponding floor plan image. Here, the scale can also be an actual distance corresponding to a pixel of the floor plan image. In another example, both of the above methods can be used to more accurately determine a distance value.

A visitor interface module 203 prompts a visitor desiring directions for a route in the venue to enter information about the desired route, such as a starting location, an end location, features to be included in the route, and accessibility concerns. The route determination module 204 can then determine a route (e.g., including turn-by-turn directions or other direction indicators) for the visitor based on the route information, the floor plan images, and the distance values. In an embodiment, the route is determined to be the shortest or most optimal route for the visitor based on the information, the distances, and/or any other relevant data, such as crowds, closed sections of the buildings, etc.

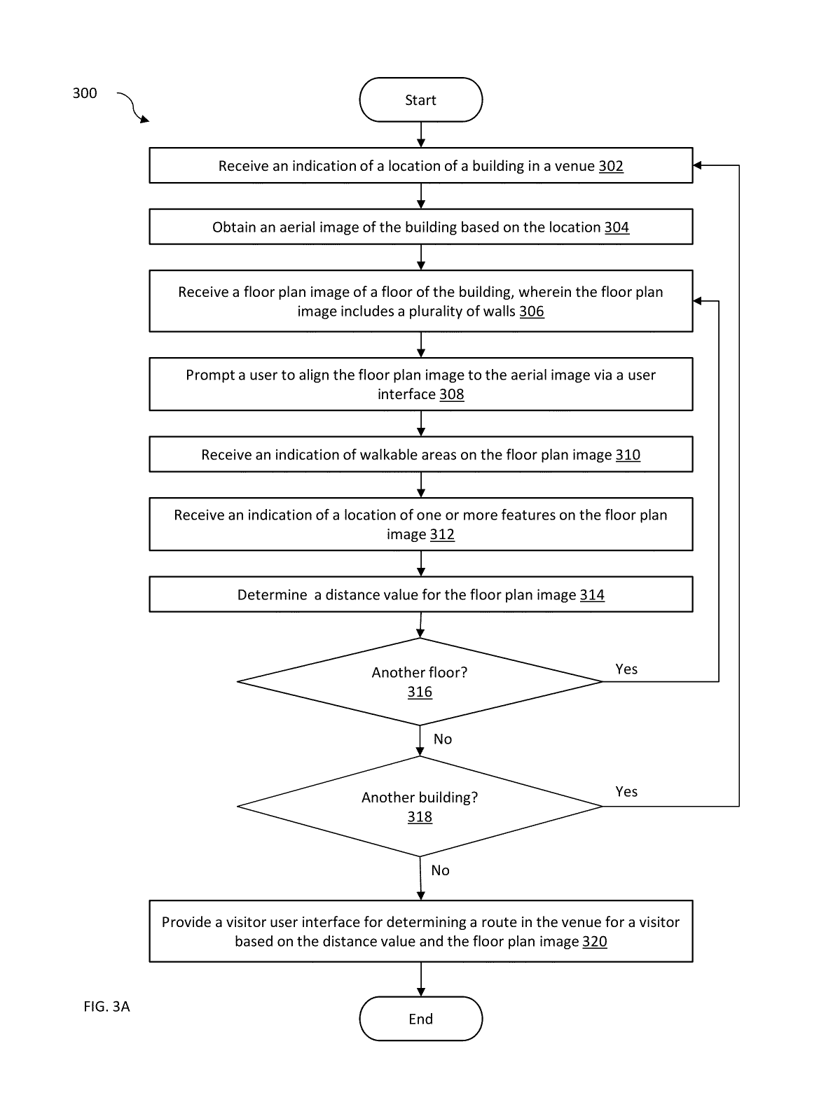

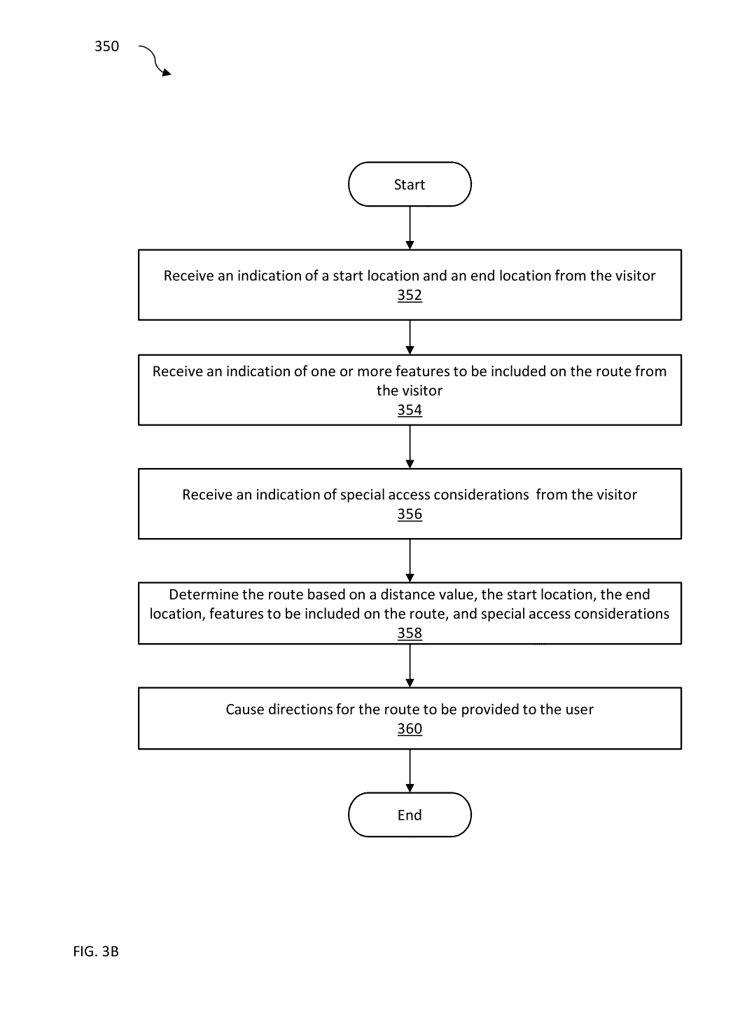

FIG. 3 is a flow diagram illustrating an embodiment for a method 300 of managing map content. The method 300 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 300 is performed by a server (e.g., the provider server 110 of FIG. 1).

At block 302, processing logic receives an indication of a location of a building in a venue. For example, for Venue A, User W can indicate Building B is a building of Venue A and an address for Building B is 221 Baker Street, London, via a website page displayed on User W's computer.

At block 304, processing logic obtains an aerial image of the building based on the location. Further to the example above, an aerial image of the Building B at 221 Baker Street, London, can be obtained, e.g., via an online aerial image provider.

At block 306, processing logic receives a floor plan image of a floor of the building, wherein the floor plan image includes a plurality of walls. Further to the example above, User W uploads a PDF file showing a floor plan image of Floor G of Building B.

At block 308, processing logic prompts a user to align the floor plan image to the aerial image via a user interface. Further to the example above, User W is prompted to rotate, scale, and/or shift the floor plan image of Floor G such that the exterior walls shown in the floor plan image are aligned with the exterior walls shown in the aerial image of Building B.

At block 310, processing logic receives an indication of walkable areas on the floor plan image. At block 312, processing logic receives an indication of a location of one or more features on the floor plan image. Further to the example above, User W indicates on the floor plan image of Floor G the walkable areas in the rooms and the hallways, the staircase, the front door, the bathrooms, e.g., using a selection tool. User W can also enter names and/or type labels for each area of the floor plan image of Floor G.

At block 314, processing logic determines a distance value for the floor plan image. Further to the example above, a distance value can be determined for the floor plan image of Floor G. For example, User W can indicate that the distance between two walls in Room H is 5 meters. A distance value (e.g., an actual distance corresponding to a pixel of the floor plan image) can be determined based on the distance between the two walls in Room H such that other distances on Floor G can also be determined based on the distance value. In another example, an exterior width of Building B known from the corresponding aerial image can be compared to a width of exterior walls shown on the floor plan image of Floor G to determine the distance value. In yet another embodiment, both methods can be utilized to determine the distance value more accurately.

At block 316, processing logic determines whether there is another floor of the building, e.g., by prompting the user to provide this information. If there is another floor of the building, then the method returns to block 306. If there is not another floor of the building, then, at block 318, processing logic determines whether there is another building in the venue, e.g., by prompting the user to provide this information. If there is another building, then the method returns to block 302. If there is not another building of the venue, then, at block 320, processing logic can provide a visitor user interface for determining a route in the venue based on the distance values and the floor plan images.

Further to the example above, User W can indicate that there is a second floor, Floor H, at Building B, and proceed through the same steps that were taken for Floor G, e.g., indicating a Room S on Floor H and indicating a staircase to travel between Floor G and Floor H. User W can also indicate that there is not another building at the Venue A.

FIG. 3B is a flow diagram illustrating an embodiment for a method 350 of managing map content. The method 350 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 350 is performed by a server (e.g., the provider server 110 of FIG. 1).

At block 352, processing logic receives an indication of a start location and an end location from the visitor. For example, Visitor A desires to visit Venue A, and she wants to know how to get from the front door to Room S, so she enters these locations as a start location and an end location, respectively, via her mobile phone.

At block 354, processing logic receives an indication of one or more features to be included on the route from the visitor. Further to the example above, Visitor A desires to stop by the restroom before she arrives at Room S, so she enters the restroom as a feature to be included on the route.

At block 356, processing logic receives an indication of special access considerations from the visitor. Further to the example above, Visitor A desires to avoid crowds on her route, so she enters avoiding crowds as a special access consideration.

At block 358, processing logic determines the route based on a distance value, the start location, the end location, features to be included on the route, and special access considerations. The route may be include directions for travel through (e.g., only through) walkable areas. In an embodiment, the route can be a shortest route including the start location, the end location, and the features to be included on the route. Further to the example above, a route can be determined for Visitor A that takes her on the shortest route from the front door to the restroom to Room S while avoiding crowds.

At block 360, processing logic causes directions for the route to be provided to the user. In an embodiment, the route can be provided via turn-by-turn directions and/or an indication on a map. Further to the example above, turn-by-turn directions for the route are sent to Visitor A's mobile phone. The directions include: go 1 meter through the door and turn right to enter the restroom, from the restroom turn right and go 1 meter to a staircase, go up the staircase, turn right, and go 2 meters to Room S.

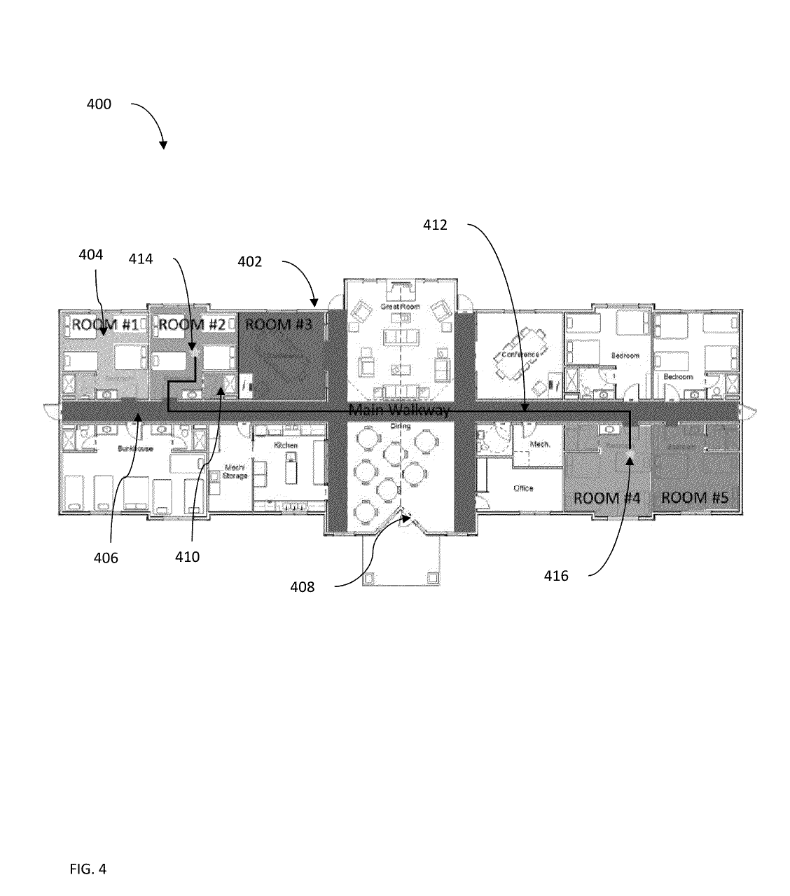

FIG. 4 is an illustration of a floor plan image 400. The floor plan image 400 includes an indication of exterior walls 402 (which can be automatically detected or manually designated), an indication of walkable space in a room 404, an indication of walkable space in a walkway 406, an indication of an entrance/exit 408, and an indication of a restroom 410. A route 412 can be displayed on the floor map image 400, where a start point 414 is indicated and an end point 416 is indicated.

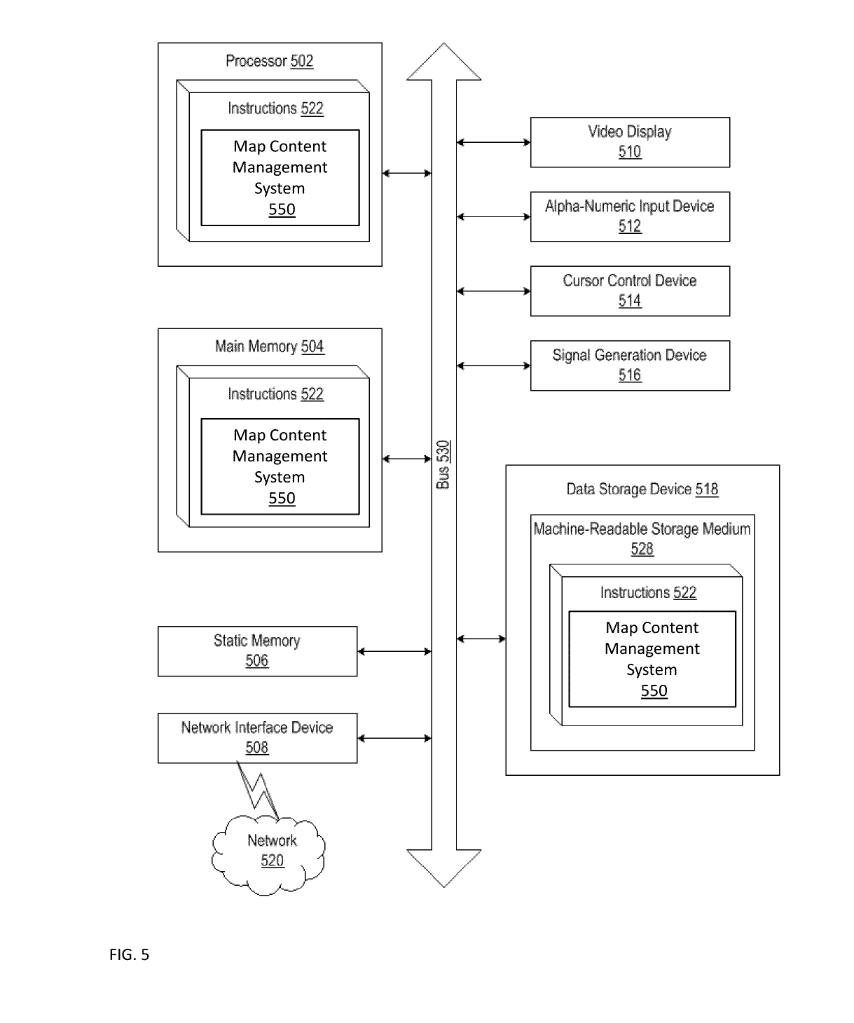

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device (processor) 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 may also be one or more special-purpose processing devices such as an application specific integrated circuit (ASIC), a field programmable gate array (FPGA), a digital signal processor (DSP), network processor, or the like. The processor 502 is configured to execute instructions 526 for performing the operations and steps discussed herein.

The computer system 500 may further include a network interface device 522. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 518 may include a computer-readable storage medium 524 on which is stored one or more sets of instructions 526 (e.g., software) embodying any one or more of the methodologies or functions described herein. The instructions 526 may also reside, completely or at least partially, within the main memory 504 and/or within the processor 502 during execution thereof by the computer system 500, the main memory 504 and the processor 502 also constituting computer-readable storage media. The instructions 526 may further be transmitted or received over a network 516 via the network interface device 522.

In one embodiment, the instructions 526 include instructions for a map content management system 550, which may correspond to map content management system 135 of FIG. 1, and/or a software library containing methods that calculate a subscribability score for a channel. While the computer-readable storage medium 524 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “computing”, “calculating”, “obtaining”, “identifying,” “modifying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

We claim:

1. A method comprising:
receiving, by a processing device, an indication of a location of a building in a venue;
obtaining, by the processing device, an aerial image of the building based on the location;
receiving, by the processing device, a primary floor plan image of a primary floor of the building, wherein the primary floor plan image comprises a primary plurality of walls;
prompting, by the processing device, a user to align the primary floor plan image to the aerial image via a user interface;
receiving, by the processing device, an indication of walkable areas on the primary floor plan image;
receiving, by the processing device, an indication of a location of a feature on the primary floor plan image;
determining, by the processing device, a distance value for the primary floor plan image; and
providing, by the processing device, a visitor user interface for determining a route in the building for a visitor based on the distance value and the primary floor plan image.

2. The method of claim 1, further comprising:
receiving an indication of a start location and an end location from the visitor;
determining the route further based on the start location and the end location; and
causing directions for the route to be provided to the visitor.

3. The method of claim 1 further comprising:
receiving a second floor plan image for another floor of the building, wherein the second floor plan image comprises a second plurality of walls;
prompting the user to align the second floor plan image to the primary floor plan image or the aerial image;
receiving an indication of walkable areas of the second floor plan image;
receiving a location of a conduit between the primary floor and the other floor;
determining a second distance value for the second floor plan image, wherein the route is determined further based on the second distance value and the second floor plan image.

4. The method of claim 1, wherein determining the distance value comprises:
receiving an indication of a distance between two walls of the plurality of walls from the user;
determining a scale of the floor plan based on the distance; and
determining the distance value based on the scale.

5. The method of claim 1, wherein determining the distance value comprises:
determining a scale of the floor plan based on a dimension of the building determined from the aerial image; and
determining the distance value based on the scale.

6. The method of claim 1 further comprising:
receiving an update of the location of the feature on the primary floor plan image from the user.

7. The method of claim 1, wherein the feature comprises an entrance to the building, a bathroom, a stairway, an elevator, or an escalator.

8. A non-transitory computer readable storage medium having instructions that, when executed by a processing device, cause the processing device to perform operations comprising:
receiving an indication of a location of a building in a venue;
obtaining an aerial image of the building based on the location;
receiving a primary floor plan image of a floor of the building, wherein the primary floor plan image comprises a primary plurality of walls;
prompting a user to align the primary floor plan image to the aerial image via a user interface;
receiving an indication of walkable areas on the primary floor plan image;
receiving an indication of a location of a feature on the primary floor plan image;
determining a distance value for the primary floor plan image; and
providing a visitor user interface for determining a route in the building for a visitor based on the distance value and the primary floor plan image.

9. The non-transitory computer readable storage medium of claim 8, wherein the operations further comprise:
receiving an indication of a start location and an end location from the visitor;
determining the route further based on the start location and the end location; and
causing directions for the route to be provided to the visitor.

10. The non-transitory computer readable storage medium of claim 8, wherein the operations further comprise:
receiving a second floor plan image for another floor of the building, wherein the second floor plan image comprises a second plurality of walls;
prompting the user to align the second floor plan image to the primary floor plan image or the aerial image;
receiving an indication of walkable areas of the second floor plan image;
receiving a location of a conduit between the floor and the other floor; and
determining a second distance value for the second floor plan image, wherein the route is determined further based on the second distance value and the second floor plan image.

11. The non-transitory computer readable storage medium of claim 8, wherein determining the distances comprises:
receiving an indication of a distance between two walls of the plurality of walls from the venue user;
determining a scale of the floor plan based on the distance; and
determining the distance value based on the scale.

12. The non-transitory computer readable storage medium of claim 8, wherein determining the distance value comprises:
determining a scale of the floor plan based on a dimension of the building determined from the aerial image; and
determining the distance value based on the scale.

13. The non-transitory computer readable storage medium of claim 8, wherein the operations further comprise:
receiving an update of the location of the feature on the primary floor plan image from the user.

14. The non-transitory computer readable storage medium of claim 8, wherein the feature comprises an entrance to the building, a bathroom, a stairway, an elevator, or an escalator.

15. A computing device comprising:
a memory; and
a processing device coupled to the memory, wherein the processing device is to:
receive an indication of a location of a building in a venue;
obtain an aerial image of the building based on the location;
receive a primary floor plan image of a floor of the building, wherein the primary floor plan image comprises a primary plurality of walls;
prompt a user to align the primary floor plan image to the aerial image via a user interface;
receive an indication of walkable areas on the primary floor plan image;
receive an indication of a location of a feature on the primary floor plan image;
determine a distance value for the primary floor plan image; and
provide a visitor user interface for determining a route in the building for a visitor based on the distance value and the primary floor plan image.

16. The computing device of claim 15, wherein the processing device is further to:
receive an indication of a start location and an end location from the visitor;
determine the route further based on the start location and the end location; and
cause directions for the route to be provided to the visitor.

17. The computing device of claim 15, wherein the processing device is further to:
receive a second floor plan image for another floor of the building, wherein the second floor plan image comprises a second plurality of walls;
prompt the user to align the second floor plan image to the primary floor plan image or the aerial image;
receive an indication of walkable areas of the second floor plan image;
receive a location of a conduit between the floor and the other floor; and
determine a second distance value for the second floor plan image, wherein the route is determined further based on the second distance value and the second floor plan image.

18. The computing device of claim 15, wherein, to determine the distance value, the processing device is to:
receive an indication of a distance between two walls of the plurality of walls from the user;
determine a scale of the floor plan based on the distance; and
determine the distance value based on the scale.

19. The computing device of claim 15, wherein, to determine the distance value, the processing device is further to:
determine a scale of the floor plan based on a dimension of the building determined from the aerial image; and
determine the distance value based on the scale.

20. The computing device of claim 15, wherein the processing device is further to:
receive an update of the location of the feature on the primary floor plan image.
